(19) United States
(12) Patent Application Publication
(10) Pub. No.: US 2014/0206319 A1
(43) Pub. Date: Jul. 24, 2014

(54) METHOD AND DEVICE FOR ACHIEVING DATA ROAMING

(71) Applicant: Tencent Technology (Shenzhen) Company Limited, Shenzhen Guangdong (CN)

(72) Inventor: Ning Lao, Shenzhen Guangdong (CN)

(73) Assignee: Tencent Technology (Shenzhen) Company Limited, Shenzhen Guangdong (CN)

(21) Appl. No.: 14/241,012

(22) PCT Filed: Feb. 19, 2013
(86) PCT No.: PCT/CN2013/071666

§ 371 Date: Feb. 25, 2014

(30) Foreign Application Priority Data
Feb. 24, 2012 (CN) 201210044064.2

(51) Int. Cl. H04L 29/06; H04W 8/02

(52) U.S. Cl. CPC H04L 63/0807; H04W 8/02
USPC 455/411

(57) ABSTRACT

The present invention is applied to the field of computer network communications, and provided are a method and device for achieving data roaming. The method comprises: a client obtaining a data roaming voucher uniquely corresponding to user logon information; the client sending a data roaming request with the data roaming voucher to a data roaming server; and according to the data roaming voucher contained in the received data roaming request, the data roaming server verifying whether the data roaming request is valid, and transmitting roaming data between the client and the data roaming server if the data roaming request is valid. Before data communication is conducted between a client and a data roaming server, the step of verifying the validity of a user data roaming request is also required, and thus, the present invention can achieve the secure isolation of user information. In addition, the data roaming server uses a user network system structure in a catalogue form, thereby ensuring the file locating expandability and universality.

### TECHNICAL FIELD

The invention relates to the field of computer network communication, and in particular, to a universal method and device for achieving data roaming.

### BACKGROUND

Data roaming refers to uploading data to save the data to a network server, so that the data may be operated on arbitrarily from anywhere. The data may be a text, a video or any other type of data, or a combination thereof. With data roaming technology, latest application data may be synchronized. The data may be accessible by clients from various devices and networks. A user may conveniently update data which may be stored on one device terminal, and access the updated data on other device terminals by data roaming without a data storage device. This may be referred to as data sharing.

FIG. 1 illustrates a structure diagram of an example data roaming system model. The model may include a data roaming server and multiple clients distributed on various device terminals and networks. The data roaming server and the clients may be connected through a network. The data roaming server may save data uploaded by the clients and synchronize user data with the other clients. The clients uploading the data may be referred to as data producers and the clients with which the data is synchronized may be referred to as data consumers. A complete frame including uploading and downloading may be formed by the model. Consider, as an example, a situation with two clients, with reference to FIG. 1, where a user uploads personal data to the data roaming server via a client 1 installed on a device terminal 1, and synchronizes the personal data saved in the data roaming server with a client 2 installed on a device terminal 2 via the client 2 when data synchronization is required. Further, the data may be saved on the device terminal 2.

The data roaming technology may have a disadvantage that user data cannot be isolated from each other. After one user uploads the personal data to the data roaming server, data synchronization may be requested by other users without verification. Consequently, a user may modify and utilize the personal roaming data of other users arbitrarily and thus user privacy may not be well protected.

### SUMMARY

In view of the problems above, a method for data roaming is provided to increase the safety of personal information of a user contained in roaming data.

The method for data roaming may include the following steps.

A client may obtain a data roaming ticket uniquely corresponding to user login information. The client may send a data roaming request including the data roaming ticket to a data roaming server. The data roaming server may verify whether the data roaming request is valid based on the data roaming ticket included in the received data roaming request. The data roaming server may also transmit and/or receive roaming data to and from the client if the data roaming request is valid.

Furthermore, the step of obtaining the data roaming ticket may include logging in to an account management server and sending a roaming ticket application including the user login information to the account management server by the client. Further, validity of a logged-in user may be verified by the account management server based on the received roaming ticket application. The account management server may forward the roaming ticket application to the data roaming server if the logged-in user is verified as valid. The data roaming server, in response, may generate the uniquely corresponding data roaming ticket based on the user login information included in the received roaming ticket application. The data roaming ticket may be forwarded to the client through the account management server, by the data roaming server and received by the client

In another aspect a device for data roaming may include a ticket obtaining unit to obtain a data roaming ticket uniquely corresponding to user login information. A roaming request unit of the device may send a data roaming request including the data roaming ticket to a ticket verification unit. The ticket verification unit may verify whether the data roaming request is valid based on the data roaming ticket included in the received data roaming request. Roaming data transmission is performed between a client and a data roaming server if the data roaming request is valid.

Furthermore, the ticket obtaining unit may include various modules described below.

An application sending module may login to an account management server and send a roaming ticket application including the user login information to a verification forwarding module of the ticket obtaining unit. The verification forwarding module may verify validity of a logged-in user based on the received roaming ticket application. The verification forwarding module may, in turn, forward the roaming ticket application to a ticket generation module if the logged-in user is verified as valid. The ticket generation module may generate the uniquely corresponding data roaming ticket based on the user login information included in the received roaming ticket application and forward the data roaming ticket to a ticket obtaining module through the account management server. The ticket obtaining module may receive the data roaming ticket forwarded by the account management server.

In the method for data roaming provided, validity of the data roaming request of the user may be verified before performing data communication between the client and the data roaming server. Therefore, since other users do not have the data roaming ticket corresponding to the user and they may not obtain the roaming data of the user via data synchronization. Thus, user information may be isolated safely from each other.

The device for data roaming provided in this disclosure includes a ticket obtaining unit and a ticket verification unit. Using, these units, validity of the data roaming request of the user may be verified before performing data communication between the client and the data roaming server. Therefore, since other users do not have the data roaming ticket corresponding to the user, they may not obtain the roaming data of the user by data synchronization. Consequently, user information may be isolated safely from each other, and the safety of the roaming data of the users may be enhanced.

### BRIEF DESCRIPTION OF THE DRAWINGS

In order to make the purpose, technical solutions and advantages of the method and device for achieving data roaming clearer, embodiments of the method and device are described in further detail below in conjunction with the accompanying drawings. The accompanying drawings and the following description are only some embodiments of the method and device for achieving data roaming and other drawings may be obtained by those skilled in the art based on these without any creative labor.

FIG. 1 is a structure diagram of an example data roaming system model.

FIG. 2 is a flow chart of an example method for data roaming according to a first embodiment.

FIG. 3 is a sequence chart showing example interaction among communication entities in a data roaming model according to a second embodiment.

FIG. 4 is a diagram showing example correspondence between a data roaming server and clients according to a third embodiment.

FIG. 5 is a frame diagram to achieve data roaming function according to a fourth embodiment.

FIG. 6 is a structure diagram of an example device for data roaming according to a fifth embodiment.

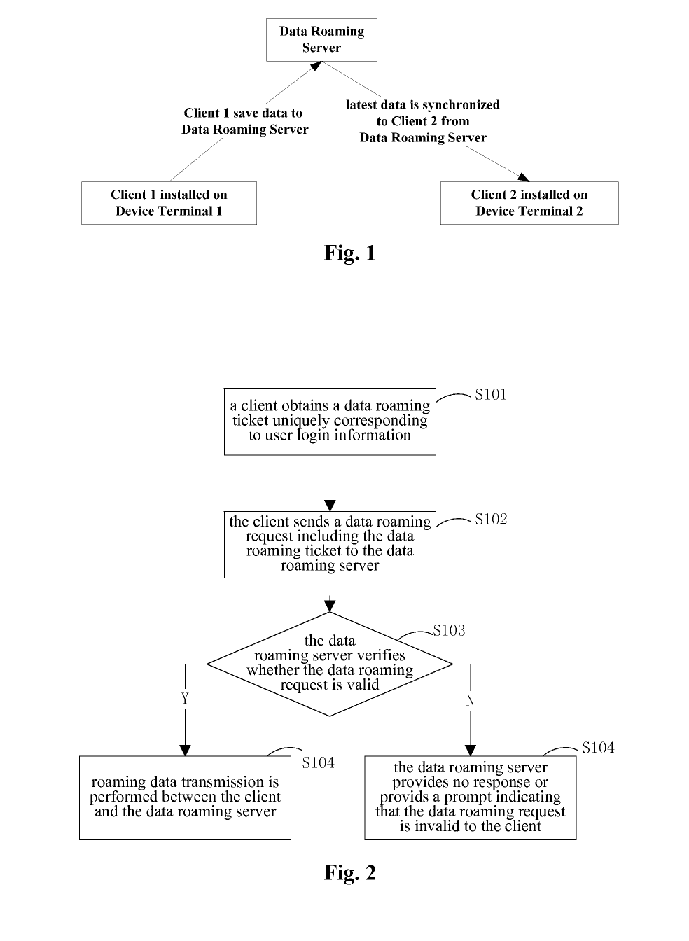

### DETAILED DESCRIPTION

The above and other technical contents, features and efficacy of the present disclosure will be clearly presented in the following detail illustration in conjunction with embodiments shown in the drawings. By the illustration of the particular embodiments, the efficacy and technology means of the technical solution presented by the present disclosure may be more deeply and specifically understood. However, the drawings are only for reference and illustration, not for limiting the solution. It is to be understood that the following description of examples of implementations are given only for the purpose of illustration and are not to be taken in a limiting sense. The partitioning of examples in function blocks, modules or units shown in the drawings is not to be construed as indicating that these function blocks, modules or units are necessarily implemented as physically separate units. Functional blocks, modules or units shown or described may be implemented as separate units, circuits, chips, functions, modules, or circuit elements. Alternatively, or in addition, one or more functional blocks or units may also be implemented in a common circuit, chip, circuit element or unit.

The embodiments of the invention relate to data communication, which may be implemented by network flow connection, between a client and a data roaming server. There may be more than one clients which may be installed on various device terminals. The data communication may include uploading user data to the data roaming server by the client. The data communication may also include synchronizing user data with other roaming clients by the data roaming server. User verification may be performed before the data communication. The user data stored on the data roaming server may only be synchronized with a roaming device if user verification is successfully completed. For example, after an Instant Messager (IM) user logs in to a client on a computer, the client, in the background, may request to upload a chat record of the user to an IM data roaming server. The IM data roaming server may store the chat record after the user is verified as valid by the IM data roaming server. The user may, at a different time, log in to the IM service through a second client of another computer. The user may request the IM data roaming server to check the chat record stored in the former computer. The IM data roaming server may synchronize the chat record data of the user stored in the server with the second client if data roaming request of the user is verified as valid by the IM data roaming server. With this approach, the data in the chat record may be isolated and the chat record of the user may not be obtained by other users.

### First Embodiment

FIG. 2 illustrates a flow chart of an example method for data roaming according to a first embodiment of the invention. The method is described in detail with the following steps.

In step S101, a client may obtain a data roaming ticket uniquely corresponding to user login information.

In one example of the embodiment, the data roaming ticket may be recognized and confirmed by a data roaming server. In an implementation, the data roaming ticket may uniquely identify the user login information of the client. The user login information may be an account uniquely identifying the user. Accordingly, the data roaming ticket may be a string of sequence codes including the account information. The data roaming server may verify whether a current data roaming request is valid, based on the sequence codes.

In step S102, the client may send the data roaming request including the data roaming ticket to the data roaming server.

According to an example of the embodiment, the client installed on a device terminal may store a communication interface of the data roaming server, and the user may send the data roaming request directly to the data roaming server through a connection network of the device terminal. The device terminal may be any device capable to communicate over the connection network, such as a desktop computer, a tablet, a laptop, a smartphone, a mobile phone, or any other device with network communication enabled.

In step S103, the data roaming server may verify whether the data roaming request is valid, based on the data roaming ticket included in the received data roaming request.

According to an example of the embodiment, whether roaming data of the user may be isolated from other user's data is determined by this step. Since the data roaming ticket may be saved in the data roaming server when the user uploads the roaming data to the server by the client, the data roaming server may determine whether the request is valid. The data roaming server may perform the check by comparing the data roaming ticket saved in the server with the data roaming ticket included in the data roaming request.

In step S104, roaming data transmission may be performed between the client and the data roaming server if the data roaming request is valid. The roaming data transmission may include uploading and synchronization of the data.

In step S105, the data roaming server may provide, to the client, no response or alternatively, may provide a prompt indicating that the data roaming request is invalid in case the data roaming request is invalid.

Thus, according to the embodiment, the data roaming server may verify whether the data roaming request of the client is valid by using the data roaming ticket. Consequently, the security of data roaming may be enhanced.

### Second Embodiment

FIG. 3 illustrates a sequence chart showing example interaction among communication entities in a data roaming model according to a second embodiment of the present disclosure. Each process for achieving data roaming is described in the sequence chart. An example approach of obtaining a data roaming ticket uniquely corresponding to user login information of a client is further described below with reference to FIG. 2. The method for data roaming according to this embodiment may include the following steps.

In step S201, the client may login to an account management server and may send a roaming ticket application, or request. The roaming ticket application may include the user login information to login to the account management server.

According to an example of the embodiment, the account management server may obtain the data roaming ticket resulting from the roaming ticket application. The account management server may verify the validity of the user. The client may be aware of a communication interface of the account management server. In an implementation, the client may automatically connect to the account management server through the communication interface when the user clicks a login button on the client.

In step S202, the account management server may verify the validity of a logged-in user based on the received roaming ticket application.

In an implementation, the account management server may verify whether the logged-in user is valid by using a password associated with a user login account set by the user. The current logged-in user may be verified as a valid user if the password is correct. The current logged-in user is verified as an invalid user if the password is incorrect. In case an invalid logged-in user is detected, the account management server may provide no response or provide a prompt with indication of an invalid user.

In step S203, the account management server may forward the roaming ticket application to the data roaming server if the logged-in user is verified as valid.

According to the embodiment, in order to decrease implementation difficulty and development cost, the account management server and the data roaming server may trust each other. Hence, the data roaming server may not verify whether the roaming ticket application forwarded by the account management server is valid.

In step S204, the data roaming server may generate the data roaming ticket based on and uniquely corresponding to the user login information included in the received roaming ticket application.

According to an implementation of the embodiment, the data roaming server may add the verification information to the received user login information. The data roaming server may package the verification information and the received user login information into the data roaming ticket. The data roaming ticket, thus, uniquely corresponds to the user login information.

In step S205, the data roaming ticket may be forwarded to the client through the account management server.

If, in the example embodiment, the account management server and the data roaming server trust each other, the account management server may forward the data roaming ticket, which is sent by the data roaming server, to the client directly without verifying whether the data roaming ticket is valid.

In step S206, the client may send the data roaming request including the data roaming ticket to the data roaming server.

In step S207, the data roaming server may verify whether the data roaming request is valid based on the data roaming ticket included in the received data roaming request.

In step S208, if the data roaming request is valid, roaming data transmission may be performed between the client and the data roaming server. If, instead, the data roaming request is deemed invalid, the data roaming server may provide no response to the client. Alternatively, the data roaming server may send, to the client, a prompt indicating that the data roaming request is invalid. The roaming data transmission may include uploading and synchronization of the data.

According to the embodiment, the account management server may be provided to verify the validity of the user, and thus the security of data roaming may be further enhanced.

### Third Embodiment

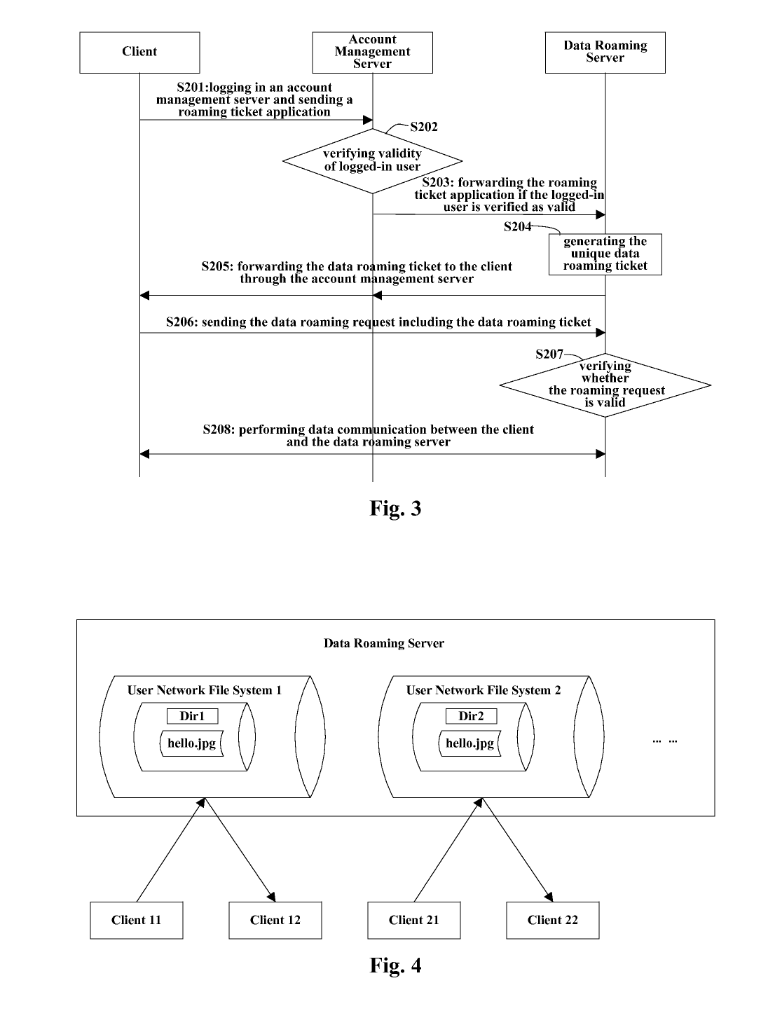

FIG. 4 illustrates example correspondence between a data roaming server and clients according to a third embodiment. The structure of the data roaming server is further described. The expandability and universality of locating and maintaining user roaming data may be ensured by applying the structure illustrated by the data roaming server. Other structures of the data roaming server to preserve the expandability and a common structure of the user data across various clients when roaming are possible and would be obvious to a person skilled in the art based on the description provided here.

The data roaming server may allocate, to each user, a user network file system for storing user data. The user network file systems may be isolated from each other. FIG. 4 illustrates an example situation with two user network file systems.

The user network file system may be similar to a local file system. A file in the user network file system may be stored in a root catalogue or a folder in the root catalogue. Here the user network file system of each user may have a root catalogue and the corresponding user may establish a child catalogue or a file in the root catalogue. A relative path may be used to identify and locate the catalogue and the file. A sign of “/” may be used to represent the root catalogue. For example, the path of the file named “Hello.jpg” in the user network file system 1 of FIG. 4 may be represented as /dir1/Hello.jpg.

Once a data roaming request is verified as valid by the data roaming server, a client 11 may upload the data to the data roaming server. The data roaming server may, in response, automatically store the uploaded data into the user network file system 1. The data may be stored in the form of catalogue and a relative path may be used to identify and locate the corresponding catalogue and user data. When the user needs to synchronize the roaming data, the data roaming server may automatically check the data in the user network file system 1. The data roaming server may synchronize the data to a client 12 after a data roaming request sent from the client 12 is verified as valid. A user network file system 2 may functions similarly. Once the data roaming server allocates a user network file system for a user, the user network file system may belong to the user. The user may establish catalogues and files in the user network file system. The user may update and obtain the roaming data by accessing files based on the paths. Thus, the expandability and universality of file locating may be ensured.

### Fourth Embodiment

FIG. 5 illustrates a block diagram illustrating components that may be used to achieve data roaming function according to a fourth embodiment. The block diagram is a structure diagram for achieving data transmission between a client and the data roaming server with an example structure shown in FIG. 4.

An important aspect of data transmission between the roaming client and the data roaming server is to perform file operations on data in a user network file system corresponding to user login information. The file operations may include, for example, deleting a file, appending a file, writing a file, reading a file and other file operations. There may be several possible techniques to implement the corresponding operations.

One technique, illustrated by FIG. 4, may include an interface layer (AppDataRoamApi), a system logic layer (AppDataRoamImpl, LocaldirMgr and VirtualDirMgr) adapted to implement the operations, a protocol layer (TfsApi) adapted to communicate with the data roaming server and a data roaming server. The interface layer may provide basic file operation interfaces, including StoreDeleteFile, StoreAppendFile, StoreWriteFile and StoreReadFile corresponding to the operations of deleting, appending, writing and reading a file respectively. The VirtualDirMgr in the system logic layer may be a virtual file system index tree. The VirtualDirMgr may identify basic information such as the number of file system catalogues, the size and timestamp of the file. The VirtualDirMgr may include two parts, i.e., VirtualDirMgr (from server) and VirtualDirMgr (locally). During initialization, the VirtualDirMgr (from server) may pull a file system index and a file timestamp from the data roaming server by invoking a function of ListDirinfo in the TfsApi. The VirtualDirMgr (from server) may further generate a virtual file catalogue structure corresponding to a server file catalogue system. The VirtualDirMgr (locally) may load the file system index cached locally when exiting the client last time from a local terminal device where the client may be installed. Differences between a local file and a user file uploaded to and stored in the server may be obtained by comparing the VirtualDirMgr (from server) and the VirtualDirMgr (locally). A specific file operation may be performed as follows.

The LocalDirMgr may be responsible for operations such as to create a catalogue, delete a catalogue, delete a file, or to identify whether a local file is the latest version, and various other such operations.

When a file is to be read by invoking the function of StoreReadFile, the operation may be implemented through the interface of AppDataRoamApi as described further. Firstly, the VirtualDirMgr (from server) may be queried to determine whether the file exists in the data roaming server. The VirtualDirMgr (locally) may also be queried to determine whether the local file is updated to a latest one. Further, the LocaldirMgr may be queried to determine whether the file exists locally. If the file exists locally and is the latest, the file may be read directly and contents transmitted to the user or an upper layer. If the file does not exist locally or if the file saved locally is not the latest, and the file exists in the data roaming server, DownloadFile function in the protocol layer TfsApi may be invoked. The DownloadFile function may pull i.e. retrieve, or download the latest file from the server. Once the file is retrieved successfully, the VirtualDirMgr (locally) may update the timestamp of the file and an identifier showing whether the file is the latest. The LocalDirMgr may, also, store the pulled file locally. The content of the file may then be read and returned to the upper layer or the user.

When other functions in the interface layer AppDataRoamApi are invoked to perform corresponding operations, the corresponding functions in the TfsApi may be directly applicable for interactions with the data roaming server. Once an operation is performed successfully, the VirtualDirMgr and LocalDirMgr may update the information of the file system and update the local file system respectively.

The data roaming according to the former embodiments is implemented with the technique illustrated in FIG. 5 to achieve data roaming. The model illustrated in FIG. 5 and described here is just one of several possible implementations of the embodiment. The model illustrated and described is not intended to limit the embodiment, and any change or equivalent substitution based on the embodiment falls within the scope of the present disclosure.

### Fifth Embodiment

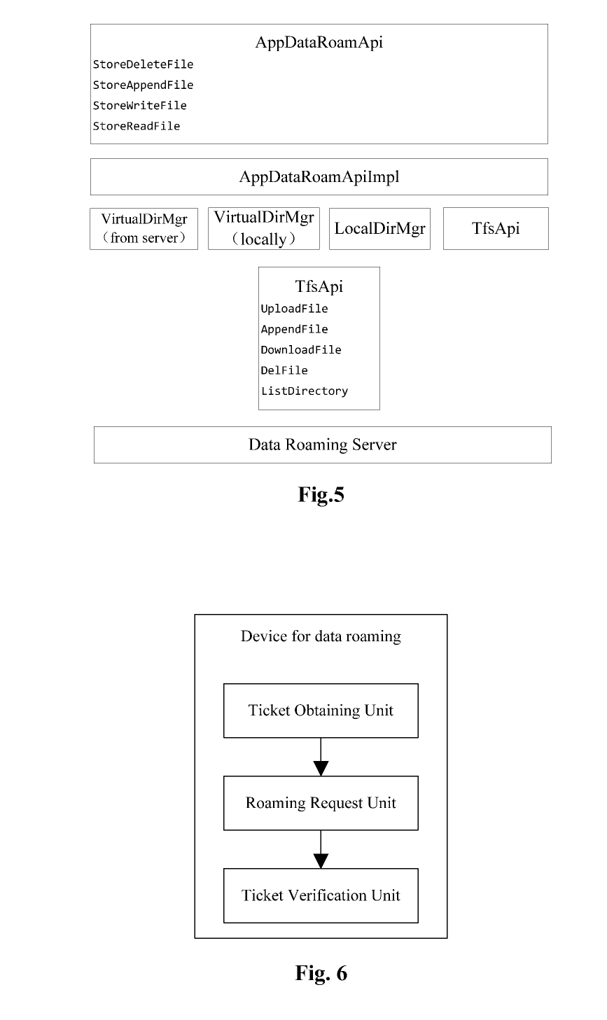

FIG. 6 illustrates the structure of an example device for data roaming according to a fifth embodiment of the invention. For convenience of illustration, only relevant parts are shown in FIG. 6.

The device for data roaming may include a ticket obtaining unit, a roaming request unit, and a ticket verification unit.

The ticket obtaining unit may obtain a data roaming ticket uniquely corresponding to user login information.

The roaming request unit may send a data roaming request including the data roaming ticket to the ticket verification unit.

The ticket verification unit may verify whether the data roaming request is valid, based on the data roaming ticket included in the received data roaming request. Roaming data transmission may be performed between a client and a data roaming server if the data roaming request is valid.

The ticket obtaining unit may further include an application sending module, a verification forwarding module, a ticket generation module, and a ticket obtaining module.

The application sending module may login to an account management server and send a roaming ticket application including the user login information to the verification forwarding module.

The verification forwarding module may verify the validity of a logged-in user based on received roaming ticket application. The verification forwarding module may, further, forward the roaming ticket application to the ticket generation module if the user is verified as valid.

The ticket generation module may generate the uniquely corresponding data roaming ticket based on the user login information included in the received roaming ticket application. The ticket generation module may, in turn, forward the data roaming ticket to the ticket obtaining module. The forwarding may be done through the account management server.

The ticket obtaining module may receive the data roaming ticket forwarded by the account management server.

The roaming request module may further include a file allocation module.

The file allocation module may allocate a user network file system for each user. The user network file system may to store user data for a corresponding user. The user data in the user network file system may exist in the form of catalogue. The corresponding catalogue and user data may be identified and located using a relative path.

Furthermore, the file allocation module may include an index establishment device.

The index establishment device may establish a virtual file index corresponding to a catalogue structure and a local file index. The local file index may load data saved locally and recently. A local file operation may be performed by comparing the two indexes and invoking a file operation interface function as required. For example, if a file listed in the local index is not the latest version of the file, the latest version of the file may be downloaded from the data roaming server by invoking the corresponding file operation interface. Once the latest file is successfully downloaded, the contents may be read.

The user roaming data may be isolated by the ticket obtaining unit and the ticket verification unit in the foregoing device for data roaming. In addition, user network system structure in the form of a catalogue may be applied in the data roaming server, and the expandability and universality of file locating may be ensured.

Another example device for data roaming is further provided. The device may include a storage to store instructions, and a processor coupled with the storage. The processor may be configured to execute the instructions stored in the storage. The processor may perform operations described in the method embodiments for achieving the data roaming, described earlier. In addition, a machine readable medium is further provided as another embodiment of the disclosure. An instruction set may be stored in the machine readable medium, where operations of the method embodiments for achieving data roaming may be performed by executing the instructions in the instruction set. The instructions may be executed by one or more processors.

Various embodiments described herein can be used alone or in combination with one another. The foregoing detailed description has described only a few of the many possible implementations of the present disclosure. For this reason, this description of example embodiments is intended by way of illustration, and not by way of limitation. Some modifications and equivalents can be made to the technical solution of the present invention by those skilled in the art in light of the technical content disclosed above without deviation from the scope of the present disclosure. Therefore, any simple change, equivalent alternation and modification made to the above embodiments according to the technical principle of the present disclosure without deviation from the scope of the present disclosure all fall within the scope of protection of the technical solution of the present disclosure. The methods, devices, and logic described above may be implemented in many different ways in many different combinations of hardware, software or both hardware and software.

1. A method for data roaming, comprising:
obtaining, by a client, a data roaming ticket uniquely corresponding to user login information;
sending, by the client, a data roaming request comprising the data roaming ticket to a data roaming server;
verifying, by the data roaming server, whether the data roaming request is valid based on the data roaming ticket comprised in the received data roaming request;
performing roaming data transmission between the client and the data roaming server if the data roaming request is valid, wherein performing the roaming data transmission between the client and the data roaming server comprises:
uploading user data to the data roaming server by the client and synchronizing stored corresponding user data with the client by the data roaming server;
allocating, by the data roaming server, a user network file system to store user data for a corresponding user, wherein the user data in the user network file system exists in a form of catalogue, and corresponding catalogue and user data are identified and located through a relative path; and
establishing, in the user network file system, a virtual file index corresponding to a catalogue structure of the user network file system and a local file index adapted to load data saved locally and recently, wherein a local file operation is performed by comparing the two indexes and invoking a file operation interface function.

2. The method for data roaming according to claim 1, wherein if the data roaming request is invalid, the data roaming server provides no response to the client or provides, to the client, a prompt indication that the data roaming request is invalid.

3. The method for data roaming according to claim 1, wherein the obtaining, by a client, a data roaming ticket uniquely corresponding to user login information comprises:
logging in an account management server and sending a roaming ticket application comprising the user login information to the account management server by the client;
verifying validity of a logged-in user based on the received roaming ticket application and forwarding the roaming ticket application to the data roaming server if the logged-in user is verified as valid by the account management server;
generating the data roaming ticket uniquely corresponding to the user login information comprised in the received roaming ticket application and forwarding the data roaming ticket to the client through the account management server by the data roaming server; and
receiving the data roaming ticket forwarded by the account management server by the client.

4. The method for data roaming according to claim 3, wherein the account management server and the data roaming server are trusted by each other and no validity verification of a request is performed between the account management server and the data roaming server during communication.

5-7. (canceled)

8. The method for data roaming according to claim 1, wherein a file reading operation comprises:
checking whether a file to be read exists locally and whether the local file is a latest one;
reading the file directly if the file exists locally and the local file is the latest one;
if the file exists in the virtual file index, pulling the file from the virtual file index to the local file index and updating a timestamp and a latest identifier of the file in the local file index, and
if the file does not exist in the virtual file index, giving a prompt indicating that the file reading operation failed by the user network file system.

9. A device for data roaming, comprising:
a ticket obtaining unit, which is adapted to obtain a data roaming ticket uniquely corresponding to user login information;
a roaming request unit, which is adapted to send a data roaming request comprising the data roaming ticket to a ticket verification unit, wherein the roaming request unit comprises a file allocation module, which is adapted to allocate a user network file system to store user data for each user, wherein the user data in the user network file system exists in a form of catalogue, and corresponding catalogue and user data are identified and located through a relative path, and
the file allocation module comprises an index establishment device, which is adapted to establish a virtual file index corresponding to a catalogue structure system and a local file index adapted to load data saved locally and recently, wherein a local file operation is performed by comparing the two indexes and invoking a file operation interface function; and
the ticket verification unit, which is adapted to verify whether the data roaming request is valid based on the data roaming ticket comprised in the received data roaming request,
wherein data roaming transmission is performed between a client and a data roaming server if the data roaming request is valid.

10. The device for data roaming according to claim 9, wherein the ticket obtaining unit comprises:
an application sending module, which is adapted to log in an account management server and send a roaming ticket application comprising the user login information to a verification forwarding module;
the verification forwarding module, which is adapted to verify validity of a logged-in user based on the received roaming ticket application and forward the roaming ticket application to a ticket generation module if the logged-in user is verified as valid;
the ticket generation module, which is adapted to generate the uniquely corresponding data roaming ticket based on the user login information comprised in the received roaming ticket application and forward the data roaming ticket to a ticket obtaining module through the account management server; and
the ticket obtaining module, which is adapted to receive the data roaming ticket forwarded by the account management server.

11-12. (canceled)
